(19) United States
(12) Patent Application Publication
(10) Pub. No.: US 2021/0187865 A1
(43) Pub. Date: Jun. 24, 2021

(54) SYSTEM AND METHOD FOR MANUFACTURING BALANCE RING ASSEMBLIES

(71) Applicant: Revere Plastics Systems, LLC, Clyde, OH (US)

(72) Inventors: Eric Berg, Castalia, OH (US); Ralph Voltz, Sandusky, OH (US); Jamie Kramer, Milan, OH (US)

(21) Appl. No.: 16/945,142

(22) Filed: Jul. 31, 2020

Related U.S. Application Data
(60) Provisional application No. 62/880,675, filed on Jul. 31, 2019.

(51) Int. Cl. B29C 65/06; B29C 65/00

(52) U.S. Cl. CPC B29C 65/0672; B29C 66/124

(57) ABSTRACT

The current disclosure provides for methods of manufacturing a balance ring assembly. Such a method includes the steps of securing an upper ring component to a drive head; securing a lower ring component to the weld joint of a base platform; moving the drive head linearly from a home position to a pre-determined touch position; upon reaching the pre-determined touch position, applying a first pressure to the upper ring component and lower ring component; rotating the drive head to move the upper ring component along a first rotational path relative to the lower ring component; and moving the drive head linearly a first distance to move the upper ring component toward the lower ring component and moving the drive head rotationally to move the upper ring component along a second rotational path relative to the lower ring component.

### CROSS REFERENCE TO RELATED APPLICATIONS

This application claims the benefit of U.S. Provisional Application No. 62/880,675, filed Jul. 31, 2020, the entirety of which is incorporated by reference herein.

### TECHNICAL FIELD

The present disclosure generally relates to systems and methods for automated welding of components. More specifically, the present disclosure relates to systems and methods for welding two matching components together using a power welder to form a balance ring assembly.

### BACKGROUND

Modern laundry washing machines are complex assemblies of many components that offer consumers a variety of features and functionality. One important component critical to the performance of washing machines is a balance ring assembly. Balance ring assemblies are designed to address a specific problem that is inherent to the operation of washing machines. Washing machines typically have a number of operational cycles, such as multiple washing cycles, rinse cycles, and spin cycles. During washing and/or rinsing cycles, the load of laundry in the clothing basket of the washing machine can concentrate on one side of the basket, resulting in an uneven load within the clothing basket. During a spin cycle, which rotates the clothing basket at a high speed to expel water from the clothing basket, if the load is unevenly distributed, the forces of the uneven spinning load can cause the clothing basket to severely wobble within the washing machine and can cause the washing machine itself to sway or oscillate to an extent that the washing machine “walks” (i.e., moves) from its desired position. Such wobbling, swaying, and undesired movement can cause damage to the washing machine and to walls and objects surrounding the washing machine. Because washing machines are typically used in a residential environment, in extreme circumstances, such undesired movement can lead to injury to persons (such as toddlers and other children) that are near the washing machine.

A balance ring assembly is designed to manage the forces produced by the spinning of uneven loads. A balance ring assembly is an enclosed hollow ring shaped receptacle typically containing a liquid, such as a water, silicone, or salt water solution. The balance ring assembly is secured around the top of the clothing basket and counteracts the forces caused by an uneven load spinning in the clothing basket at a high rate of speed. In essence the balance ring assembly is “weighted” to stabilize the clothing basket and the washing machine itself during spin cycles, resulting in the clothing basket spinning smoothly regardless of the distribution of the load of laundry in the clothing basket.

Balance ring assemblies are commonly constructed by securing two matching components together to form a hollow ring shaped container with internal features. Balance ring assemblies are typically made of a robust structural polymeric material. One common method of securing the two matching components together is through a welding process. For efficiency and consistency, the manufacturing processes used for balance ring assemblies are typically automated.

Prior art manufacturing processes for welding two matching components together into a balance ring assembly are problematic in that such processes have difficulty consistently producing a high-quality product in high-volume automated manufacturing processes. In particular, the prior art manufacturing processes have difficulty in properly and consistently positioning the two matching components (relative to each other) during the welding of the two matching components. Such difficulties results in an inferior and/or inconsistent seal between the two matching components. Thus, the liquid within the balance ring assembly, which is critical to its operation, can leak out of the balance ring assembly over time to degrade the balance ring assembly's efficacy and performance.

There is a need in the industry for systems and methods that achieve a repeatable and consistent seal along the interface between the two matching components that form balance ring assemblies. Novel systems and methods to achieve this goal are disclosed herein.

### SUMMARY

The current disclosure provides for methods of manufacturing a balance ring assembly. Such a method includes the steps of securing an upper ring component to a drive head; securing a lower ring component to the weld joint of a base platform; moving the drive head linearly from a home position to a pre-determined touch position; upon reaching the pre-determined touch position, applying a first pressure to the upper ring component and lower ring component; rotating the drive head to move the upper ring component along a first rotational path relative to the lower ring component; and moving the drive head linearly a first distance to move the upper ring component toward the lower ring component and moving the drive head rotationally to move the upper ring component along a second rotational path relative to the lower ring component.

### BRIEF DESCRIPTION OF THE DRAWINGS

FIG. 1 schematically illustrates a perspective view of a balance ring assembly.

FIG. 2 schematically illustrates a perspective view of a portion of the balance ring assembly of FIG. 1.

FIG. 3 schematically illustrates a top view of a portion of the balance ring assembly of FIG. 1.

FIG. 4 schematically illustrates a front view of a portion of the balance ring assembly of FIG. 1.

FIG. 5 schematically illustrates a cross-sectional view of a portion of the balance ring assembly of FIG. 1.

FIG. 6 schematically illustrates a perspective view of a portion of an upper ring component used to manufacture a balance ring assembly.

FIG. 7 schematically illustrates another perspective view of a portion of an upper ring component used to manufacture a balance ring assembly.

FIG. 8 schematically illustrates a perspective view of a portion of an upper ring component used to manufacture a balance ring assembly.

FIG. 9 schematically illustrates a perspective view of a portion of a lower ring component used to manufacture a balance ring assembly.

FIG. 10 schematically illustrates another perspective view of a portion of a lower ring component used to manufacture a balance ring assembly.

FIG. 11 schematically illustrates a perspective view of a portion of a lower ring component used to manufacture a balance ring assembly.

FIG. 12 schematically illustrates the positioning of balance ring components during prior art manufacturing processes.

FIG. 13 schematically illustrates the positioning of balance ring components during novel manufacturing processes disclosed herein.

FIG. 14 schematically illustrates a perspective view of a power welding machine.

FIG. 15 schematically illustrates a front view of a power welding machine.

FIG. 16 schematically illustrates a top view of a power welding machine.

FIG. 17 schematically illustrates balance ring components secured to a power welding machine.

FIG. 18 schematically illustrates balance ring components secured to a power welding machine.

### DETAILED DESCRIPTION

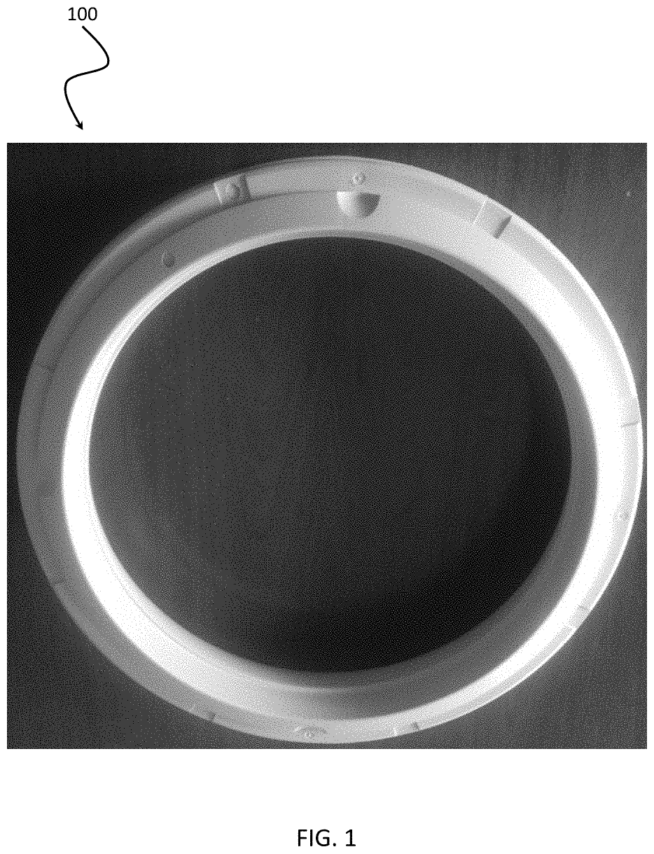

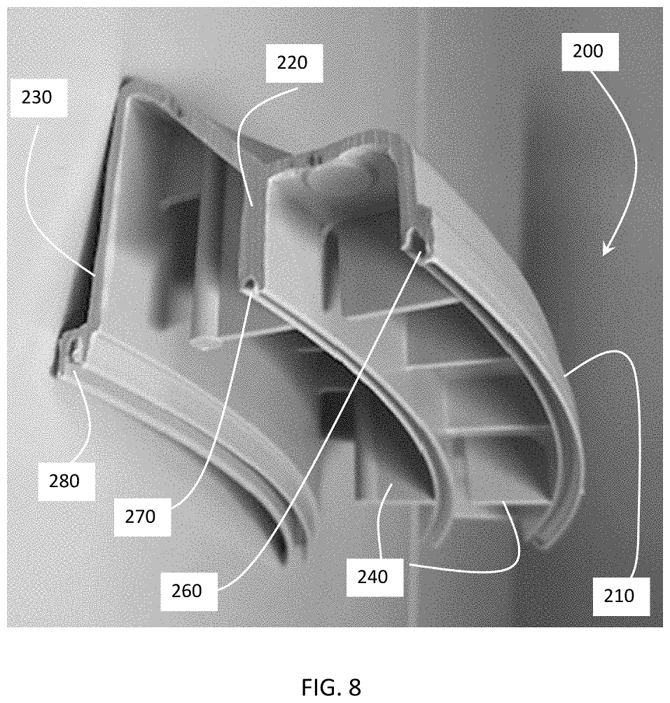

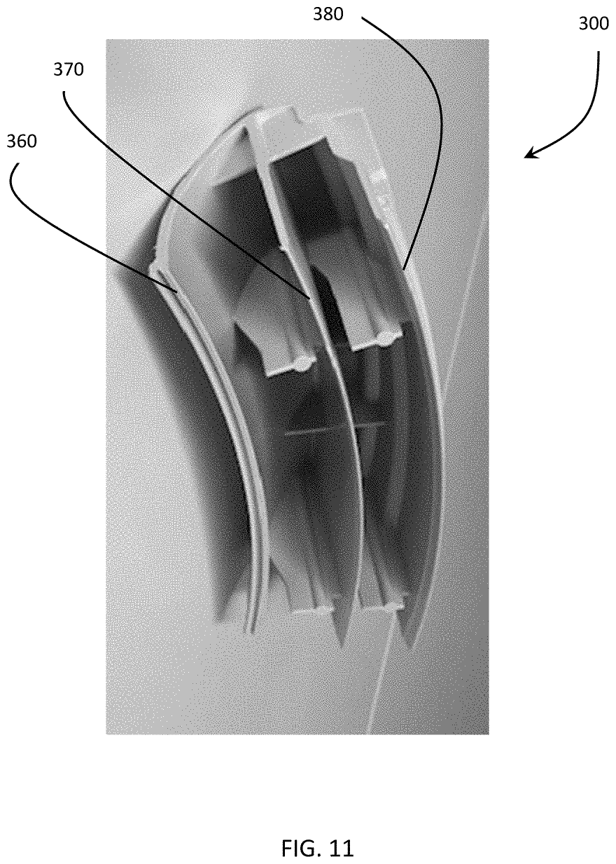

The apparatus, systems, arrangements, and methods disclosed in this document are described in detail by way of examples and with reference to the figures. It will be appreciated that modifications to disclosed and described examples, arrangements, configurations, components, elements, apparatus, methods, materials, etc. can be made and may be desired for a specific application. In this disclosure, any identification of specific techniques, arrangements, method, etc. are either related to a specific example presented or are merely a general description of such a technique, arrangement, method, etc. Identifications of specific details or examples are not intended to be and should not be construed as mandatory or limiting unless specifically designated as such. Selected examples of systems and methods for forming balance ring assemblies for use with laundry washing machines are hereinafter disclosed and described in detail with reference made to FIGS. 1-18.

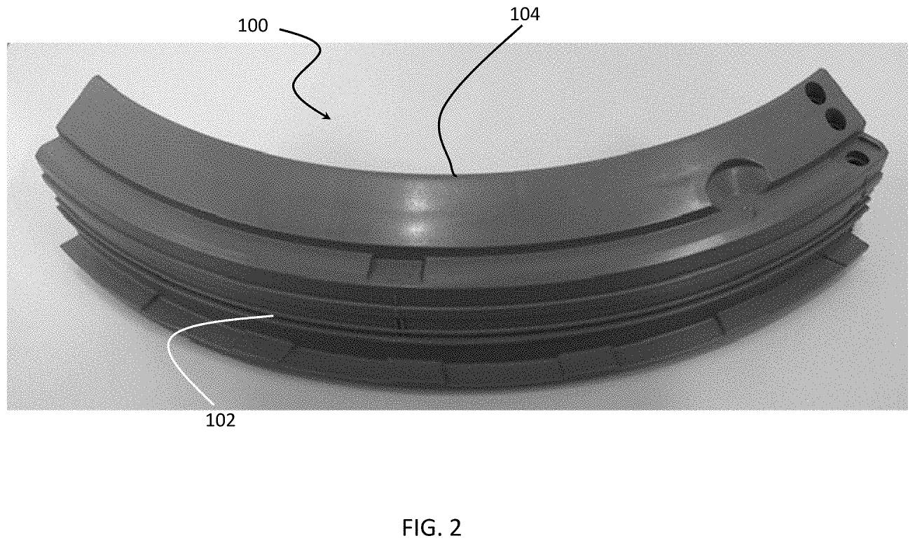

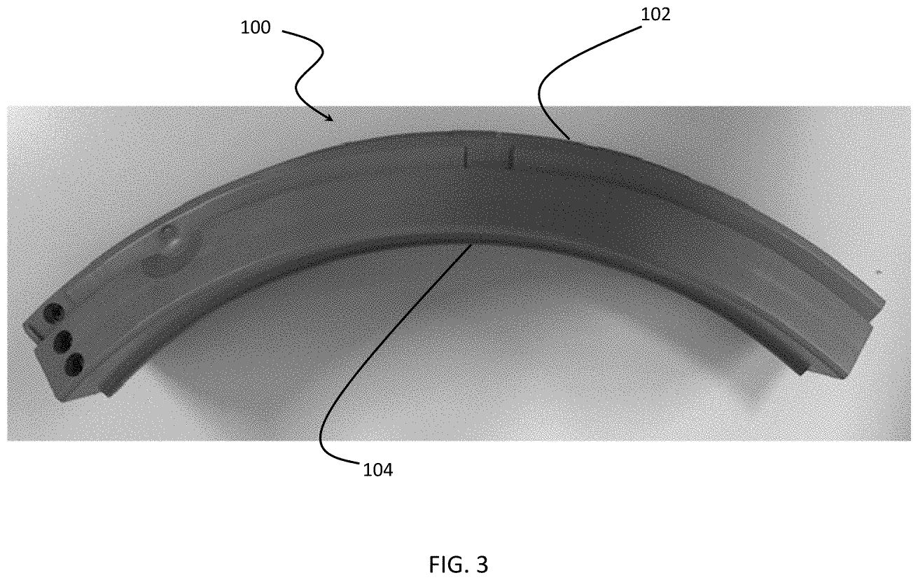

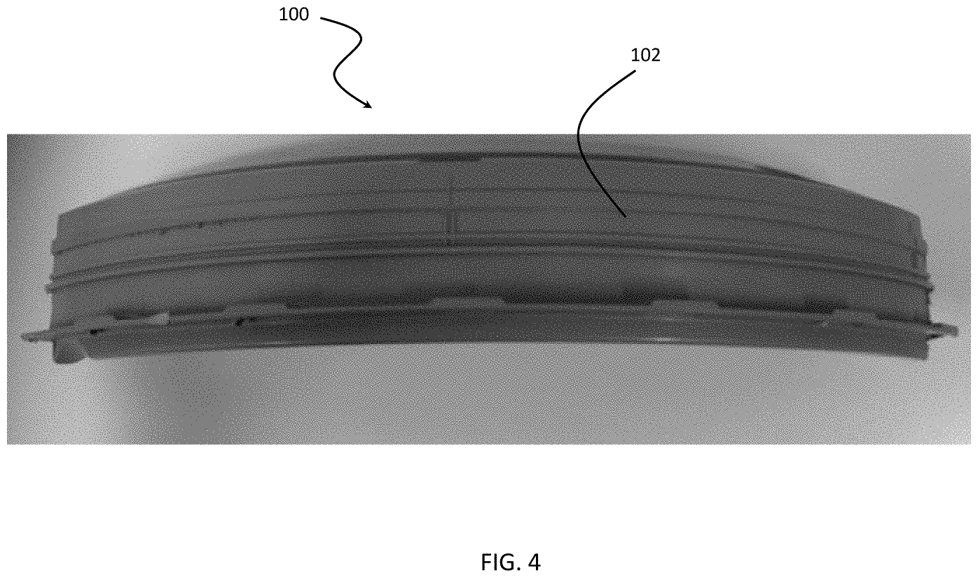

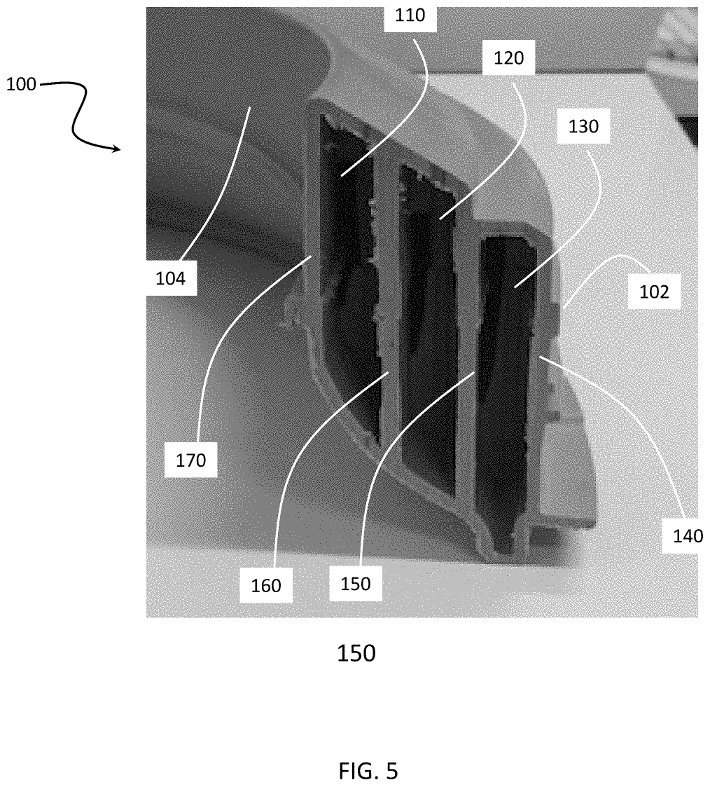

The result of the systems and methods described herein is a fully fabricated balance ring assembly. In addition to novelty of the systems and methods used to form the balance ring assembly, such systems and methods provide for design changes to the individual components of the balance ring assembly that result in a novel balance ring assembly as well. FIGS. 1-5 schematically illustrate various views of one embodiment of a balance ring assembly 100. FIG. 1 is a perspective view of the balance ring assembly 100, FIG. 2 is a perspective view of a portion of the balance ring assembly 100, FIG. 3 is a top view of a portion of the balance ring assembly 100, FIG. 4 is a side view of a portion of the balance ring assembly 100, and FIG. 5 is a cross-sectional view of the balance ring assembly 100.

The balance ring 100 has an outside perimeter 102 and an inside perimeter 104 that bound the interior of the balance ring assembly 100. It is noted that throughout this disclosure, the terms “inside” and “outside” are used to refer to location along these perimeters of the balance ring assembly 100, with “inside” referring to the inside perimeter 102 of the balance ring 100 and “outside” referring to the outside perimeter 104 of the balance ring assembly 100. In the embodiment illustrated in FIGS. 1-5 (as best viewed in FIG. 5) the interior of the balance ring assembly 100 includes a series of three channels (110, 120, 130) formed by an outside wall 140, a first interior wall 150, a second interior wall 160, and an inside wall 170. The walls (140, 150, 160, 170). The channels (110, 120, 130) are continuous along the entire circumference of the balance ring assembly 100; thus, the three channels (110, 120, 130) are each continuous and segregated channels that each can contain fluids, such as a water, silicone, or salt water solution, independent of the other two channels. While the example of the balance ring assembly 100 of FIGS. 1-5 includes three channels (110, 120, 130), other examples of balance ring assemblies can include more channels or less channels than illustrated in FIG. 5.

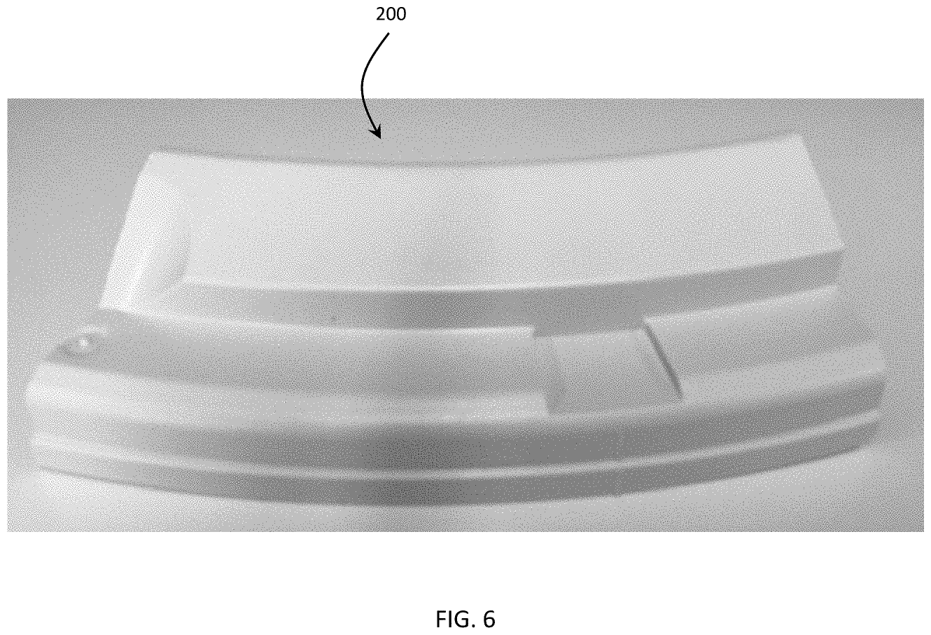

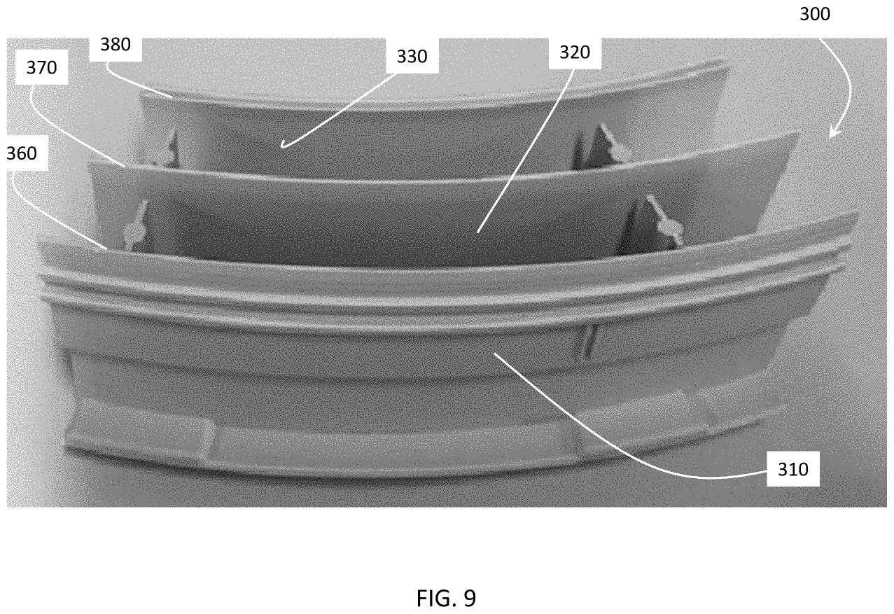

Typically, the novel balance ring assemblies disclosed herein include two components—an upper ring component 200 (illustrated in FIGS. 6-8) and a lower ring component 300 (illustrated in FIGS. 9-11). Unlike the balance ring assembly 100 of FIGS. 1-5. the upper 200 and lower 300 ring components illustrated in FIGS. 6-11 form a balance ring assembly with two channels defined by an outside wall, one internal wall, and an inside wall.

The upper ring component 200 includes a number of features such as an outside wall section 210, an interior wall section 220, an inside wall section 230, and a series of baffle sections 240. Similarly, the lower ring component 300 includes a number of features that match the features of the upper ring component 200 such as an outside wall section 310, an interior wall section 320, an inside wall section 330, and a series of baffle sections 340. When the upper ring component 200 and lower ring component 300 are assembled into a balance ring assembly, the features of the upper ring component 200 and the features of the lower ring component 300 align and/or interact to form defined internal features of the balance ring assembly.

For example, the outside wall section 210 of the upper ring component 200 and the outside wall section 310 of the lower ring component are positioned in contact with each other and joined to form an outside wall of the balance ring assembly. The interior wall section 220 of the upper ring component 200 and the interior wall section 320 of the lower ring component are positioned in contact with one another and joined to form an interior wall of the balance ring assembly. Once assembled, the outside wall and interior wall form a first channel between the walls. The inside wall section 230 of the upper ring component 200 and the inside wall section 330 of the lower ring component are positioned in contact with each other and joined to form an inside wall of the balance ring assembly. Once assembled, the inside wall and interior wall form a second channel between the walls. The baffle sections 240 of the upper ring component 200 and the baffle sections 340 of the lower ring component are positioned aligned and adjacent to each other when the ring components (200, 300) are joined to form a balance ring assembly. Such positioning forms a series of baffles inside the channels of the balance ring assembly. While there may remain a small gap between matching baffle sections, the aligned and adjacent baffle sections generally perform as one continuous baffle.

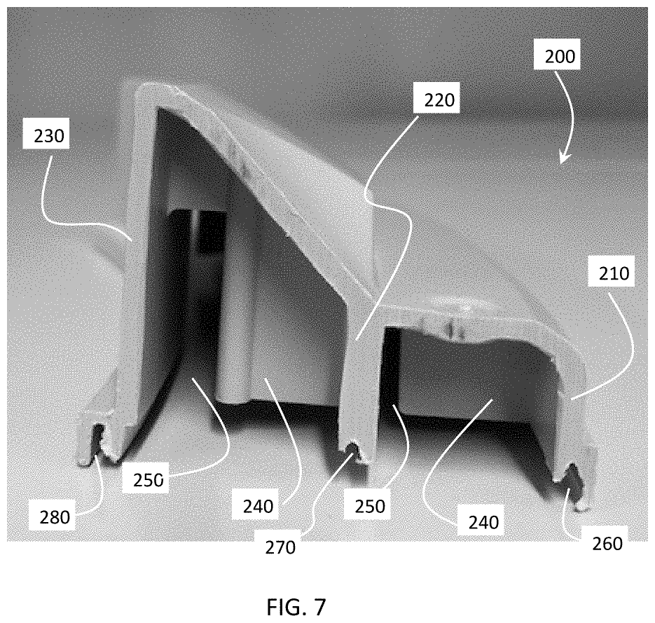

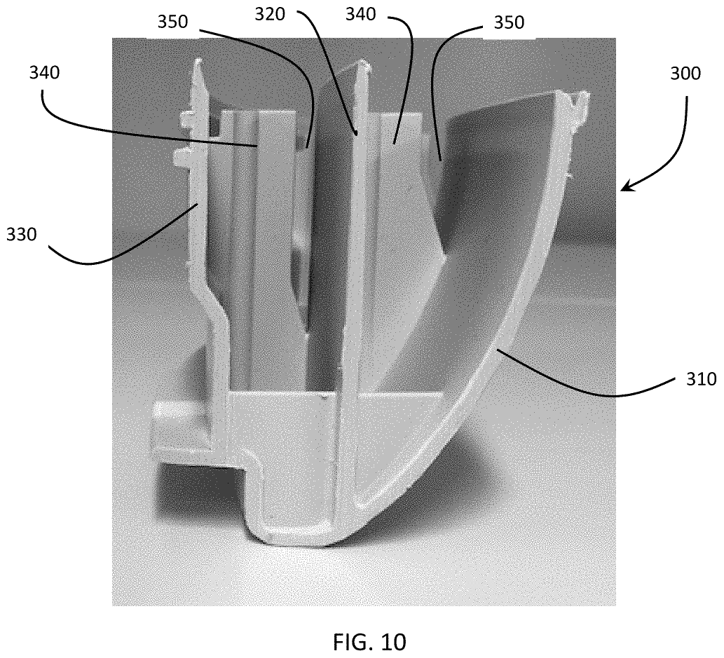

The baffles formed by the baffle sections (240, 340) can be designed and positioned to regulate the flow of fluid within the channels. As best illustrated in FIGS. 7 and 10, the baffle sections (240, 340) are designed such that gaps (250, 350) are formed between the baffle sections (240, 340) and the walls (220, 260, 320, 330). While the baffles generally limit the wholesale flow of fluid throughout the channels, such gaps (250, 350) proximate to the baffles allow for controlled fluid movement throughout the channel, which is important for the balance ring assembly to counteract the forces generated by a spinning unbalanced load. The number of baffles, the positioning of the baffles, the size and shape of the baffles, and the size and shape of the gaps can be selected to achieve the proper fluid regulation for any application of a balance ring assembly.

The upper 200 and lower 300 ring components include additional features that facilitate the assembly of the ring components (200, 300) into a balance ring assembly. For example, the upper ring component 200 includes a groove 260 along the outside wall portion 210, a groove 270 along the interior wall portion 220, and a groove 280 along the inside wall portion 230. The lower ring component 200 includes an edge 360 along the outside wall portion 310, an edge 370 along the interior wall portion 320, and an edge 380 along the inside wall portion 330. When the ring components (200, 300) are ready to be joined, the edges (360, 370, 380) of the lower ring component 200 are positioned into the grooves (260, 270, 280) of the upper ring component 300. Such positioning improves alignment of the ring components (200, 300) and result in a superior seal between the ring components (200, 300).

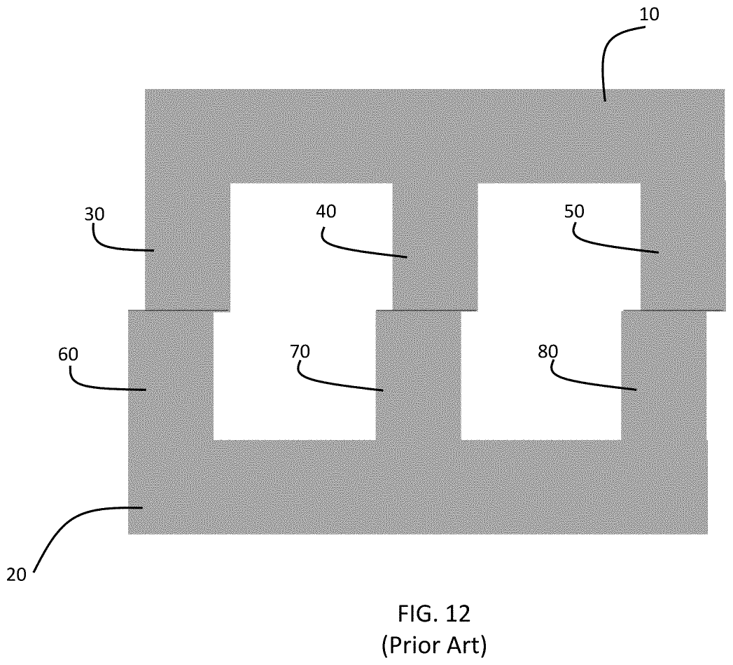

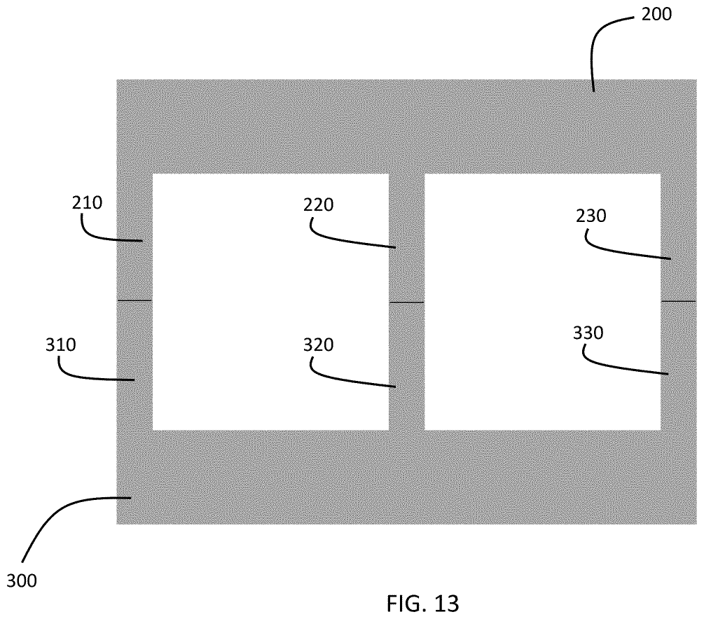

One prior art problem solved by the systems and methods disclosed herein is the misalignment of certain features of ring components during assembly. For example, as schematically illustrated in FIG. 12, when assembling prior art ring components (10, 20), prior art manufacturing processes had difficulty aligning the wall segments (30, 40, 50, 60, 70, 80) (and baffles, not shown) of ring components (10, 20). This necessitated relatively thick wall segments (30, 40, 50, 60, 70, 80) to compensate for such misalignment. When such misalignments were more substantial than illustrated in FIG. 12, the seal between the ring components (10, 20) could be compromised, which commonly led to leaking of fluid contained inside the balance ring assembly at the interface of the wall segments (30, 40, 50, 60, 70, 80). As schematically illustrated in FIG. 13, when alignment is not an issue, as with the novel systems and methods disclosed herein, the wall segments (210, 220, 230, 310, 320, 330) can be thinner and still assure a high quality seal at the interface of the wall segments (210, 220, 230, 310, 320, 330). It will be understood that the option of designing thinner wall segments has a number of benefits including reduction of material costs and flexibility of design to improve the regulation of fluid flow through the balance ring assembly.

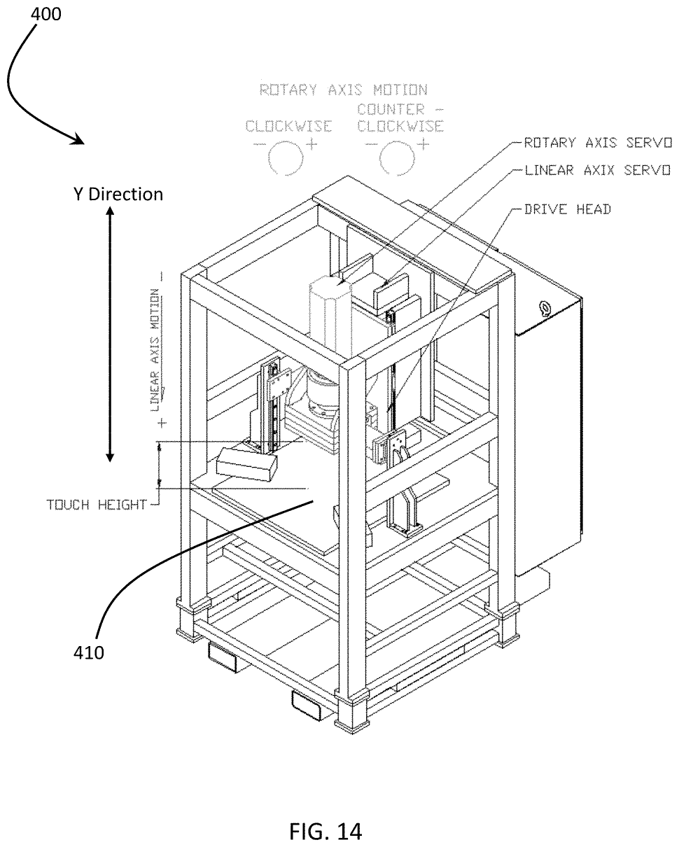

A power welding machine 400 for assembling ring components to form a balance ring assembly is illustrated in FIGS. 14-16. The power welding machine 400 functions as a spin welder. Spin welding operates by placing two plastic components in contact with one another (one stationary component and one rotatable component), generating frictional heat by rotating one component relative to the other component, and forming a welded circular joint along the points of contact between the components. During the spin welding process, linear force is applied to the rotating component to generate the desired amount of frictional heat to melt plastic on both components at the interface between the components. Once the melted plastic cools and solidifies, a weld joint is formed at the interface of the components.

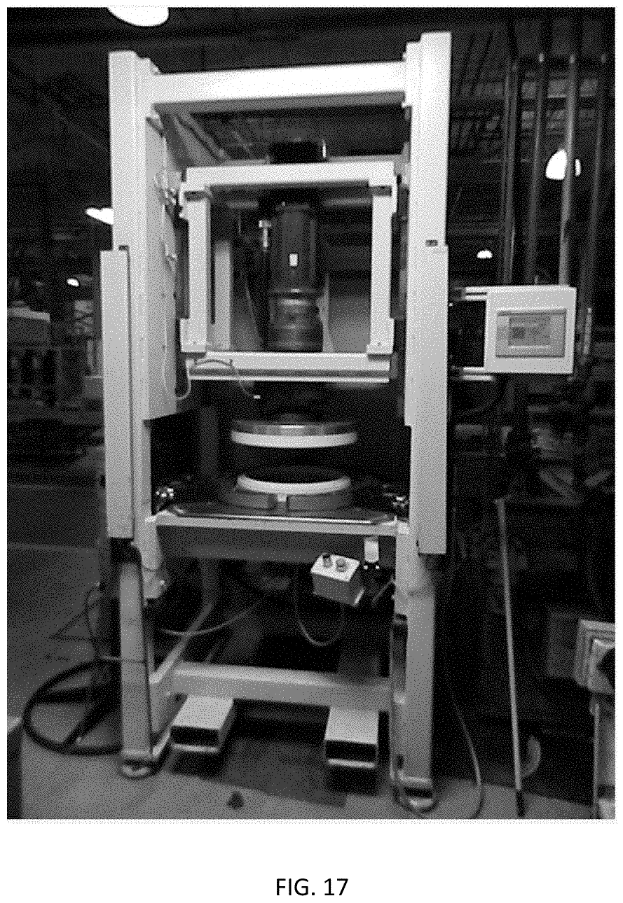

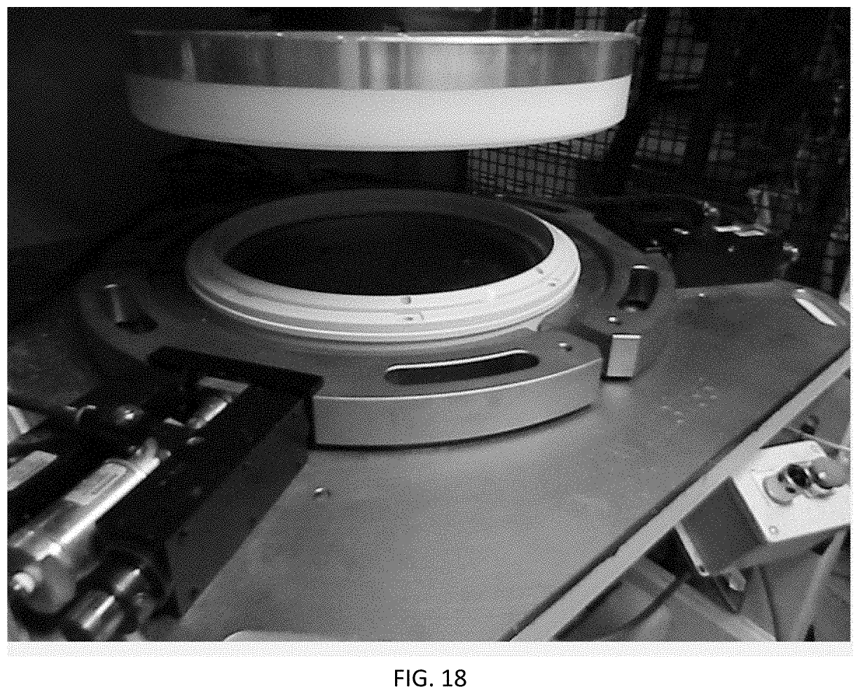

The power welding machine 400 includes a base platform 410 with fixturing (i.e., a pre-load weld joint) to secure a lower ring component to the base platform 410 and a drive head 420 with fixturing that secures the upper ring component to the drive head 420. FIGS. 17 and 18 illustrate the power welding machine 400 with the lower ring component secured to the base platform and the upper ring component secured to the drive head.

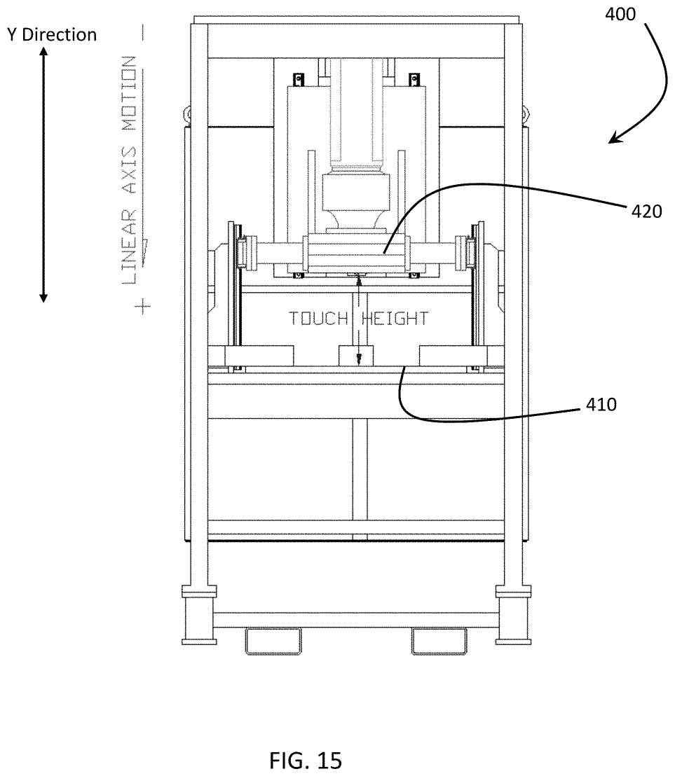

As best illustrated in FIG. 15, at rest, the drive head 420 is positioned away from the base platform 410 so that there is room between the base platform 410 and drive head 420 for an operator to install the ring components and remove a completed balance ring assembly. This is often referred to as a “home” position. Typically the drive head 420 begins and ends each manufacturing cycle (i.e., the fabrication of a balance ring assembly) at the home position. Typically, the distance between drive head 420 at the home position and location at which the ring components are first placed into contact with each other during the fabrication processes is referred to as “touch height” or “touch position.”

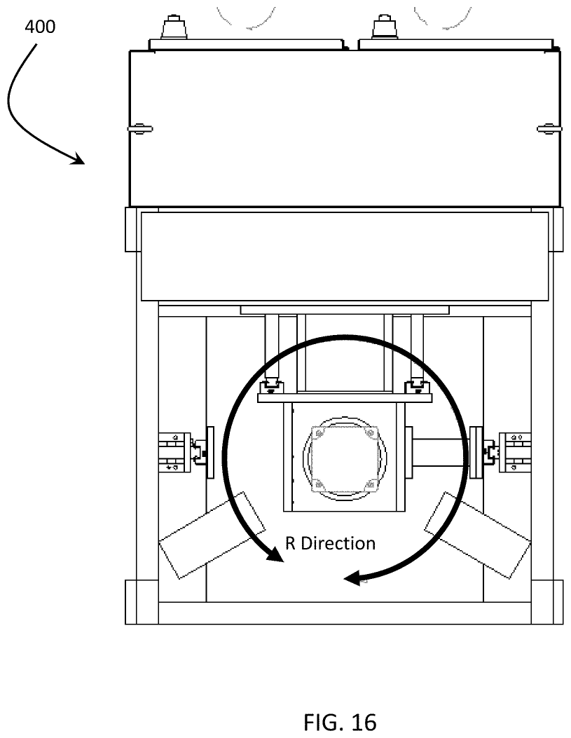

The lower ring component is secured to the pre-load weld joint of the base platform 410 in a static position. This is to say that once the lower component ring is secured to the pre-load weld joint of the base platform 410, the lower component ring will not move (either rotationally, vertically, or horizontally) during the manufacturing process. The drive head 420 is capable of both vertical displacement (i.e., movement along the Y-direction as illustrated in FIGS. 14 and 15) and rotational displacement (i.e., movement along the R-direction as illustrated in FIG. 16). Thus, once the upper ring component is secured to the drive head 420, the drive head 420 can move the upper ring component vertically relative to the lower ring component and/or rotationally relative to the lower ring component. To facilitate such movement of the drive head 420, the power welding machine 400 includes a linear servo motor 430 and a rotational servo motor 440.

The power welding machine 400 further includes a controller. The controller includes a set of instructions that determine a number of manufacturing parameters for each manufacturing cycle, including movement, both linearly and rotationally, of the drive head; temperatures of welding stages; applied pressure of welding stages; and duration of welding stages. With regard to weld stages, one exemplary manufacturing process includes five stage: (1) drive head deployment stage; (2) pre-weld stage; (3) welding stage; (4) hold stage; and (5) drive head retracting stage.

The first stage of the exemplary manufacturing process—the drive head deployment stage—is initiated once the upper ring component is secured to the drive head and the lower ring component is secured to the pre-load weld joint of the base platform. During this stage, the drive head begins at the home position and moves to its pre-established touch position. This stage ensures correct physical engagement of upper ring component with the fixturing of the driver head and correct physical engagement of the lower ring component with the pre-load weld joint of the base platform. During the first stage, the drive head moves linearly downward in the Y-direction to the touch position at a specified velocity, at a specified acceleration rate, and at a specified deceleration rate. There is no rotational movement during the first stage. The touch position, velocity, acceleration, and deceleration are variable based on particularities of the ring components and the desired end results. At the end of the first stage, a specific pressure can be applied to the areas of physical engagement between the ring components. The pressure can be varied, based on desired results for the second stage, from approximately 2 pounds per square inch (psi) to approximately 4000 psi.

The second stage—the pre-weld stage—is initiated once the touch position is confirmed in the first stage and the desired pressure is applied to the ring components. The second stage is referred to as a “pre-weld” stage because it is intended to soften the plastic of the ring components and prepare the plastic for welding. During this stage, the drive head moves only rotationally, and there is no linear displacement of the drive head. The drive head rotates the upper ring component through a specific rotational path, at a specified velocity, at a specified acceleration rate, and at a specified deceleration rate. The velocity, acceleration, and deceleration are variable based on particularities of the ring components and the desired end results.

The third stage—the weld stage—initiates at the completion of the pre-welding stage. During this stage, the drive head moves both rotationally and linearly downward. The drive head rotates the upper ring component through a specific rotational path and moves the upper ring component a specific distance downward into the lower ring component. The rotational movement is at a specified velocity, at a specified acceleration rate, and at a specified deceleration rate. The velocity, acceleration, and deceleration of the rotational movement are variable based on particularities of the ring components and the desired end results. The linear downward movement is at a specified velocity, at a specified acceleration rate, and at a specified deceleration rate. The velocity, acceleration, and deceleration of the linear downward movement are variable based on particularities of the ring components and the desired end results. As will be understood, as the plastic of the ring components melds and the drive head moves the upper ring component downward, the melted plastic flows and intermingles to form a seal between the upper and lower ring components.

The fourth stage—hold stage—is optional. At the end of the weld stage, the ring components can be statically held together for a certain period of time and under a prescribed pressure to allow for the plastic to fully cool and solidify the weld joint. The time and pressure is selected based on particularities of the ring components and the desired end results. The pressure can typically range between 4 psi and 8000 psi.

The fifth stage—drive head retraction stage—moves the drive head back to its home position. This stage includes both rotational and linearly upward movement. Both the rotational and linearly upward movement are at a specified velocity, specified acceleration rate, and a specified deceleration rate. At the completion of the fifth stage, the balance ring assembly can be removed from the fixturing and new ring components can be securing to the fixturing to begin the next cycle of the manufacturing process.

As previously noted, there are several variables for the manufacturing process disclosed herein. Table 1 below describes parameters for one embodiment of the balance ring assembly manufacturing process.

TABLE 1

| Stage | Displacement | Setting | | Notes |
|---|---|---|---|---|
| First | Vertical Displacement | | | Only vertical |
| Stage | Distance | −162.15 ± 5 | mm from home position | displacement |
| | Velocity | 75 | mm/s | |
| | Acceleration | 100 | mm/sec² | |
| | Deceleration | −100 | mm/sec² | |
| | Radial Displacement | | | |
| | Distance | 0 | degrees | |
| | Velocity | 0 | rpm | |
| | Acceleration | 0 | rads/sec² | |
| | Deceleration | 0 | rads/sec² | |
| Second | Vertical Displacement | | | Only |
| Stage | Distance | 0 | mm | rotational |
| | Velocity | 0 | mm/s | displacement |
| | Acceleration | 0 | mm/sec² | |
| | Deceleration | 0 | mm/sec² | |
| | Radial Displacement | | | |
| | Distance | 211.5 ± 5 | degrees | |
| | Velocity | 80 | rpm | |
| | Acceleration | 75 | rads/sec² | |
| | Deceleration | 75 | rads/sec² | |
| Third | Vertical Displacement | | | Radial and |
| Stage | Distance | −3.6 ± 0.5 | mm from position after second stage | vertical |
| | Velocity | 75 | mm/s | displacement |
| | Acceleration | 100 | mm/sec² | |
| | Deceleration | −100 | mm/sec² | |
| | Radial Displacement | | | |
| | Distance | 329 ± 5 | degrees | |
| | Velocity | 80 | rpm | |
| | Acceleration | 75 | rads/sec² | |
| | Deceleration | 75 | rads/sec² | |
| Fourth | Hold time | 1.00 | seconds | No radial or |
| Stage | Clamp status | Clamps on | | vertical |
| | Clamp advance | 1.00 | seconds | displacement |
| | delay | | | |
| | Weld direction | counterclockwise | | |
| Fifth | Vertical Displacement | | | Both radial |
| Stage | Distance | Return to home position | | and vertical |
| | Velocity | 75 | mm/s | displacement |
| | Acceleration | 75 | mm/sec² | |
| | Deceleration | 75 | mm/sec² | |
| | Radial Displacement | | | |
| | Distance | Return to home position | | |
| | Velocity | 30 | rpm | |
| | Acceleration | 15 | rads/sec² | |
| | Deceleration | 15 | rads/sec² | |

The parameters described in Table 1 are but one example of a set of parameters for a process for manufacturing balance ring assemblies. Other sets of parameters can be used with the five stage process described herein.

The foregoing description of examples have been presented for purposes of illustration and description. It is not intended to be exhaustive or limiting to the forms described. Numerous modifications are possible in light of the above teachings. Some of those modifications have been discussed, and others will be understood by those skilled in the art. The examples were chosen and described in order to best illustrate principles of various examples as are suited to particular uses contemplated. The scope is, of course, not limited to the examples set forth herein, but can be employed in any number of applications and equivalent devices by those of ordinary skill in the art.

We claim:

1. A method of manufacturing a balance ring assembly, the method comprising:
securing an upper ring component to a drive head;
securing a lower ring component to the weld joint of a base platform;
moving the drive head linearly from a home position to a pre-determined touch position;
upon reaching the pre-determined touch position, applying a first pressure to the upper ring component and lower ring component;
rotating the drive head to move the upper ring component along a first rotational path relative to the lower ring component; and
moving the drive head linearly a first distance to move the upper ring component toward the lower ring component and moving the drive head rotationally to move the upper ring component along a second rotational path relative to the lower ring component.

2. The method of claim 1, further comprising applying a second pressure to the upper ring component and the lower ring component for a first period of time.

3. The method of claim 1, further comprising moving the drive head linearly to the home position.

4. The method of claim 1, wherein the distance from the home position to the pre-determined touch position is approximately 162.15 mm.

5. The method of claim 4, wherein the average linear velocity of the drive head moving from the home position to the pre-determined touch position is 75 mm/second, with an acceleration of 100 mm/second² and a deceleration of 100 mm/second².

6. The method of claim 1, wherein the first rotational path is approximately 211.5 degrees.

7. The method of claim 6, wherein the average rotational velocity of the drive head moving along the first rotational path is 80 rads/second, with an acceleration of 75 rads/second² and a deceleration of 75 rads/second².

8. The method of claim 1, wherein the first distance is approximately 3.6 mm.

9. The method of claim 8, wherein the average linear velocity of the drive head moving the first distance is 75 mm/second, with an acceleration of 100 mm/second² and a deceleration of 100 mm/second².

10. The method of claim 9, wherein the second rotational path is approximately 329 mm.

11. The method of claim 10, wherein the average rotational velocity of the drive head moving along the second rotational path is 80 rads/second, with an acceleration of 75 rads/second² and a deceleration of 75 rads/second².

12. The method of claim 2, wherein the first hold time is approximately one second.

13. The method of claim 3, wherein the average linear velocity of the drive head moving to the home position is 75 mm/second, with an acceleration of 75 mm/second² and a deceleration of 75 mm/second².

14. The method of claim 13, wherein the average rotational velocity of the drive head moving to the home position is 30 rads/second, with an acceleration of 15 rads/second² and a deceleration of 15 rads/second².
